(19) United States
(12) Patent Application Publication
(10) Pub. No.: US 2026/0298766 A1
(43) Pub. Date: Oct. 1, 2026

(54) METHOD AND DEVICE FOR DETERMINING THE CONDITION OF A BRIDGE

(71) Applicant: Kistler Holding AG, Winterthur (CH)

(72) Inventors: David CORNU, Frauenfeld (CH); Thomas WUHRMANN, Frauenfeld (CH)

(21) Appl. No.: 19/629,089

(22) Filed: Mar. 26, 2026

(30) Foreign Application Priority Data
Mar. 27, 2025 (EP) 25166755.6

(51) Int. Cl. G01M 5/00

(52) U.S. Cl. CPC G01M 5/0008; G01M 5/0041; G01M 5/0066

(57) ABSTRACT

A method for determining the condition of a bridge that includes a traffic sensor for detecting the load of vehicles traveling over the bridge and generates load data for the detected load. An evaluation unit evaluates the load data. A structure sensor detects a structural response of the bridge, which structural response includes at least one of the following physical quantities: a vibration, a strain, a displacement, or a change in inclination, and the structure sensor generates structural data for the detected structural response. The evaluation unit links the load data and the structural data and generates a condition profile of the bridge, which condition profile represents a temporal development of the load of the vehicles and the structural response of the bridge.

### TECHNICAL FIELD

The invention relates to a structural health monitoring method and device for determining the condition of a bridge.

### BACKGROUND OF THE INVENTION

Aging of the nation’s roadways and bridges raises the need to assess their current state of serviceability and both where and when failures may occur. In the United States, more than 150,000 of the bridges that are more than 50 years old are deemed deficient or obsolete. Moreover, even today’s healthy bridges face rising traffic, vehicle overloading, extreme weather, and poor maintenance. Structural health monitoring (SHM) refers to the continuous or periodic and automated process of determining the condition of an infrastructure such as a bridge. This is accomplished using a permanently installed measuring data device and by analyzing the measurement data. In this way damages such as cracks or deformations in the infrastructure are meant to be detected at an early stage so that countermeasures can be taken.

Document WO14089591A1, which corresponds to US Patent Application Publication No. 2015-0316426, which by this reference is hereby incorporated herein in its entirety for all purposes, describes such a SHM for a bridge using a traffic sensor for the detection of traffic over the bridge. The traffic sensor is designed as a weigh-in-motion (WIM) sensor, which detects the load of vehicles traveling over the bridge. The WIM sensor is located in the foundation of the bridge and measures the structural response of the bridge under the load of the vehicles. For this purpose, said WIM sensor generates measurement data. The measurement data are transmitted from the WIM sensor to an evaluation unit for analysis. Thus, said evaluation unit uses the time course of the measurement data to determine the number of wheel axles of each vehicle or monitors the measurement data for exceeding a predefined threshold value.

Now, doubts may arise as to whether the measurement data generated by the WIM sensor actually originate from traffic via the bridge, or whether they have another cause, such as damage to the bridge or an earthquake in the area of the bridge.

### OBJECTS AND SUMMARY OF THE INVENTION

The object of the present invention is to improve the method known from document WO14089591A1 for determining the condition of a bridge. In particular, certainty should be established as to whether the structural response of the bridge actually originates from traffic over the bridge.

This object is solved by the features described below.

The invention relates to a method for determining the condition of a bridge and includes at least one traffic sensor for detecting the load of vehicles traveling over the bridge, from which traffic sensor load data are generated for each detected load. An evaluation unit is operatively connected to each traffic sensor and configured for evaluating the load data received from each traffic sensor. The bridge is provided with at least one structure sensor operatively connected to the bridge and to the evaluation unit and configured for detecting a structural response of the bridge, which structural response includes at least one of the following physical quantities: a vibration, a strain, a displacement, or a change in inclination, from which structure sensor structural data are generated by each structure sensor for the detected structural response. The evaluation unit is configured to link the load data and the structural data to form a condition profile of the bridge, which condition profile represents the temporal development of the load of the vehicles and the structural response of the bridge. In general, the method also desirably includes providing the bridge’s condition profile as input data to other systems to be further processed during operation of such other systems. One example of such other systems is an overloading vehicle identification monitor that employs cameras to record images of a vehicle traveling on the bridge at particular times, combines the image data with vehicle registration data to identify the owner of the vehicle and uses the bridge’s condition profile to match the vehicle’s overloading effect on the bridge to determine whether the owner of the vehicle should be assessed a traffic fine.

The invention also relates to a device for determining the stress on a bridge. The device includes at least one traffic sensor configured for detecting the load of vehicles traveling over the bridge, and desirably a plurality of such traffic sensors is included in the device. Each traffic sensor is configured to generate load data for the detected load of the traveling vehicle. The device includes an evaluation unit configured for evaluating the load data. The device includes at least one structure sensor configured for detecting a structural response of the bridge, and desirably a plurality of such structure sensors is included in the device. The range of structural response that might be detected by a given structure sensor includes at least one of the following physical quantities: a vibration, a strain, a displacement, or a change in inclination. Each structure sensor is configured to generate structural data for the detected structural response. The evaluation unit is configured to link the load data and the structural data to generate a condition profile of the bridge, which condition profile represents the temporal development of the load of the vehicles and the structural response of the bridge to the load of the vehicles.

According to the invention, the load of the vehicles traveling over the bridge is recorded in a spatially separate manner from the detection of the structural response of the bridge. By linking the load data and structural data recorded in a spatially separate manner, a cause-and-effect relationship can be established between the temporal development of the load of the vehicles on the bridge and the structural response of the bridge. Only this cause-and-effect relationship provides certainty that the structural response of the bridge is actually caused by traffic crossing the bridge and is not due to damage to the bridge or an earthquake in the area of the bridge.

Advantageous embodiments of the invention are described below with greater elaboration on more of their particulars.

### BRIEF DESCRIPTION OF THE DRAWINGS

In the following, the invention will be explained by way of example in more detail with reference to the figures, in which:

FIG. 1 provides a view of a part of a first embodiment of a bridge B and a schematic representation of a part of a first embodiment of a device D for determining a condition profile P of the bridge B at a time point t2 are shown;

FIG. 3 provides a view of a part of a second embodiment of a bridge B and a schematic representation of a part of a second embodiment of a device D for determining a condition profile P of the bridge B at a time point t1 are shown;

FIG. 4 provides a top view of a part of the second embodiment of bridge B according to FIG. 3 with a part of the second embodiment of device D for determining a condition profile P of bridge B at a time point t3 is shown;

FIG. 5 provides a schematic representation of an example of a condition profile P of the first embodiment of the bridge B according to FIGS. 1 and 2 at time points t1 – t4 is shown; and

FIG. 6 provides a schematic representation of an example of a condition profile P of the second embodiment of the bridge B according to FIGS. 3 and 4 at time points t1 – t4 is shown.

Throughout the figures, identical reference numerals denote identical objects in the figures.

### DETAILED DESCRIPTION OF EXEMPLARY EMBODIMENTS OF THE INVENTION

### THE BRIDGE B

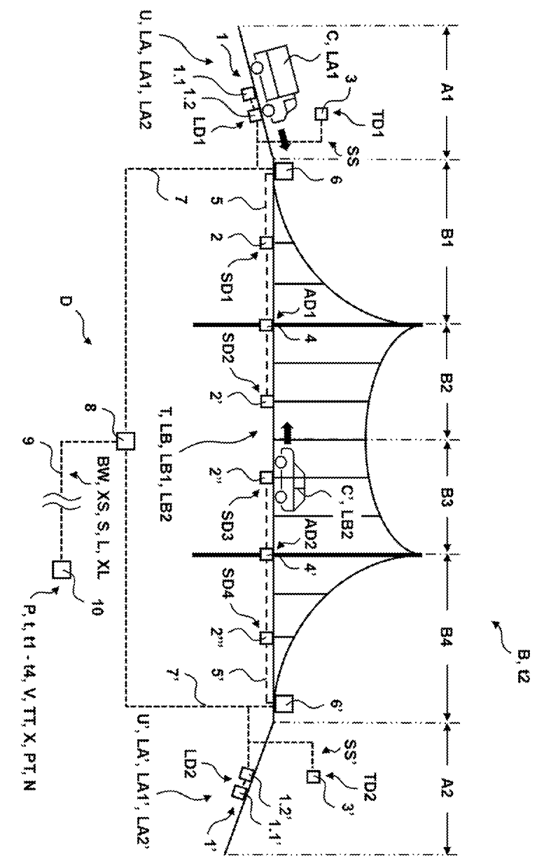

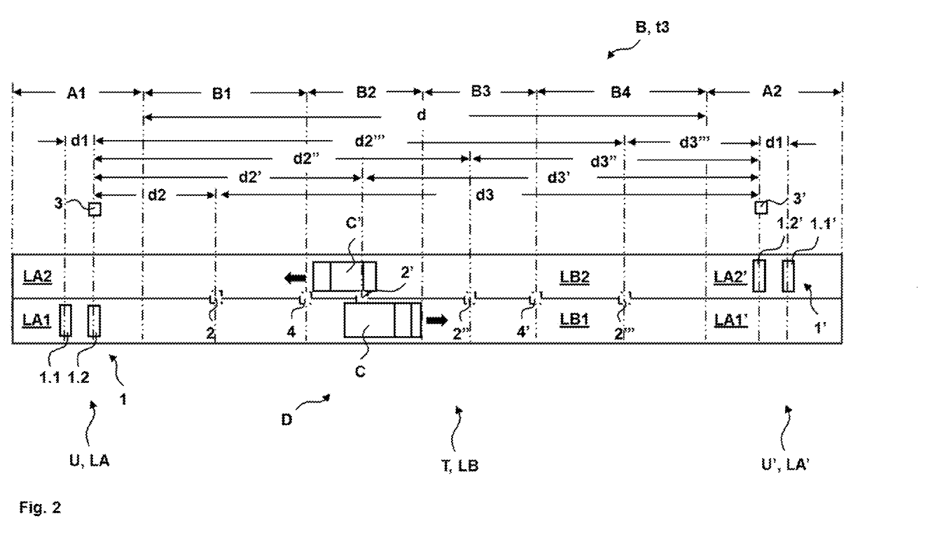

FIGS. 1-4 schematically show parts of two embodiments of a bridge B. The bridge B is configured to perform the function of enabling vehicles C, C' to cross an obstacle disposed beneath the bridge B, which spans over the obstacle and extends for a length at least a long enough for the vehicles C, C’ to avoid encountering the obstacle. For this purpose, said vehicles C, C' travel over the bridge B.

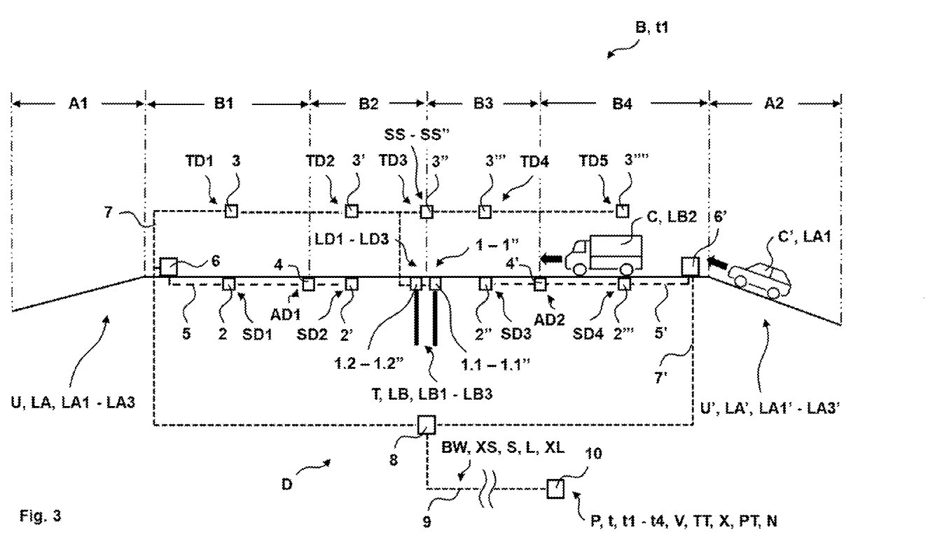

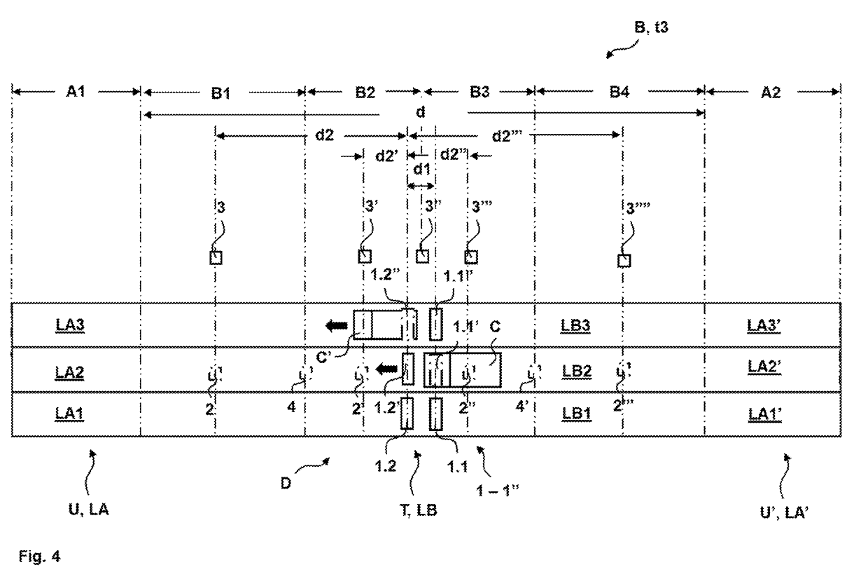

The bridge B comprises a structure T and at least one roadway LB that supports the vehicles C', C' traveling across the bridge B. Said structure T consists of approved materials such as iron, steel, concrete, brick, wood, and so on. In the first embodiment of the bridge B according to FIGS. 1 and 2, the bridge B is constructed as a suspension bridge, and the structure T consists mainly of tensioned steel cables and steel girders that support the roadway LB from above the roadway LB. In the second embodiment of bridge B according to FIGS. 3 and 4, the bridge B is constructed as a prestressed concrete bridge, and structure T consists mainly of concrete slabs and concrete girders that support the roadway LB from beneath the roadway LB.

In the examples according to FIGS. 1-4, a plurality of vehicles C, C' include a first vehicle C and a second vehicle C'. The first vehicle C is a truck with a load of 10,000 kg, and the second vehicle C' is a passenger car with a load of 2,000 kg. Of course, the person skilled in the art can implement the invention with a plurality of vehicles that includes more than two vehicles C, C’.

Preferably, the roadway LB of the bridge B defines a plurality of traffic lanes LB1 – LB3 disposed side-by-side across the width of the roadway LB. In the first embodiment of bridge B according to FIGS. 1 and 2, traffic lanes LB1 – LB3 include a first traffic lane LB1 for vehicles C, C' traveling in a first direction from left to right, and a second traffic lane LB2 for vehicles C, C' traveling in a second direction from right to left. In the second embodiment of bridge B according to FIGS. 3 and 4, traffic lanes LB1, LB2 and LB3 include a first traffic lane LB1, a second traffic lane LB2, and a third traffic lane LB3. In each of the three traffic lanes LB1 – LB3, the vehicles C, C' travel in the second travel direction from right to left. The travel direction of vehicles C, C' is indicated by bold arrows.

The bridge B is defined by a plurality of bridge sections B1, B2, B3 and B4, which include a first bridge section B1, a second bridge section B2, a third bridge section B3, and a fourth bridge section B4. The bridge sections B1 – B4 adjoin each another lengthwise along the bridge B. In the two embodiments of the bridge B according to FIGS. 1-4, the first bridge section B1 adjoins the second bridge section B2 on the left side, the second bridge section B2 adjoins the third bridge section B3 on the left side, and the third bridge section B3 adjoins the fourth bridge section B4 on the left side. Of course, the person skilled in the art can implement the invention with a number of bridge sections other than four.

### THE ACCESS ROADS A1, A2

FIGS. 1-4 schematically show two embodiments of access roads A1 and A2 to the bridge B. The access roads A1 and A2 are located outside bridge B at each of the opposite ends of the bridge B and are therefore not part of bridge B on an underground U, U'. The underground U, U' consists of proven materials such as earth, concrete, and so on. The access roads A1, A2 include a first access road A1 on a first underground U and a second access road A2 on a second underground U'. The first access road A1 adjoins the first bridge section B1 on the left side, and the second access road A2 adjoins the fourth bridge section B4 on the right side. Of course, the person skilled in the art can implement the invention with a number of access roads other than two.

The respective access roads A1 and A2 are designed as ramps with a respective roadway LA and LA' for vehicles C and C'. In the embodiment of access roads A1 and A2 according to FIGS. 1 and 2, the first access road A1 includes a first roadway LA and the second access road A2 includes a second roadway LA'. Preferably, each roadway LA, LA' defines a plurality of traffic lanes LA1, LA2 and LA3, LA1’, LA2’ and LA3'. In the first embodiment of the access roads A1, A2 according to FIGS. 1 and 2, the traffic lanes LA1 – LA3 of the first roadway LA include a first traffic lane LA1 for the movement of vehicles C, C' in the first travel direction and a second traffic lane LA2 for the travel of vehicles C, C' in the second travel direction. The traffic lanes LA1 – LA3 of the second roadway LA' include a first traffic lane LA1' for the movement of vehicles C, C' in the first travel direction and a second lane LA2' for the movement of vehicles C, C' in the second travel direction. In the second embodiment of the access roads A1, A2 according to FIGS. 3 and 4, the traffic lanes LA1 – LA3 of the first roadway LA include a first traffic lane LA1, a second traffic lane LA2, and a third traffic lane LA3. The traffic lanes LA1' – LA3' of the second roadway LA' include a first traffic lane LA1', a second traffic lane LA2' and a third traffic lane LA3'. In all three traffic lanes LA1 – LA3, LA1' – LA3' of the two roadways LA, LA', vehicles C, C' travel in the second direction of travel from right to left.

The movement of vehicles C and C' via access roads A1 and A2 and bridge B takes place at designated time points t1 to t4. The time points t1 – t4 include in consecutive succession, a first time point t1, a second time point t2, a third time point t3, and a fourth time point t4. The time points t1 –t4 occur sequentially. The second time point t2 occurs after the first time point t1, the third time point t3 occurs after the second time point t2, and the fourth time point t4 occurs after the third time point t3.

In the first embodiment of the access roads A1, A2, and the bridge B according to FIGS. 1 and 2, the first vehicle C travels at the second time point t2 on the first traffic lane LA1 of the first access road A1 in the first travel direction towards bridge B, while the second vehicle C' travels at the second time point t2 on the second traffic lane LB2 in the third bridge section B3 of bridge B in the second travel direction. At the third time point t3, the two vehicles C and C' cross each other in the second bridge section B2 of bridge B.

In the second embodiment of said access roads A1, A2 and the bridge B according to FIGS. 3 and 4, the first vehicle C travels at the first time point t1 on the second traffic lane LB2 in the fourth bridge section B4 of the bridge B in the second travel direction, and the second vehicle C' travels at the first time point t1 on the first traffic lane LA1' of the second access road A2 in the second travel direction towards the bridge B. At the third time point t3, the second vehicle C' traveling on the third traffic lane LB3 overtakes the first vehicle C traveling on the second traffic lane LB2 at the boundary between the second and third bridge sections B2, B3 on bridge B.

### THE TRAFFIC SENSOR 1, 1'

The device D includes at least one traffic sensor 1 – 1''. Each traffic sensor 1 – 1'' is configured to perform the function of detecting the load of each of the plurality of vehicles C, C' traveling over the bridge B.

In the first embodiment of device D according to FIGS. 1 and 2, each traffic sensor 1 – 1'' is installed in at least one roadway LA, LA' of the plurality of access roads A1, A2. The plurality of traffic sensors 1 – 1'' includes a first traffic sensor 1, which is installed in the first roadway LA of the first access road A1, and a second traffic sensor 1', which is installed in the second roadway LA' of the second access road A2.

In the second embodiment of the device D according to FIGS. 3 and 4, each of the plurality of traffic sensors 1 – 1'' is installed in at least one roadway LB1 – LB3 of the bridge B. The plurality of traffic sensors 1 – 1'' includes a first traffic sensor 1, which is installed in the first roadway LB1 in the boundary area of the second and third bridge sections B2, B3, a second traffic sensor 1', which is installed in the second roadway LB2 in the boundary area between the second and third bridge sections B2, B3, and a third traffic sensor 1'', which is installed in the third roadway LB3 in the boundary area between the second and third bridge sections B2, B3.

When one of the plurality of vehicles C, C' travels over the traffic sensor 1 – 1'' installed in the roadway LA, LA' of the access roads A1, A2 or the roadway LB of the bridge B, that one traffic sensor 1 – 1'' detects the load of this one vehicle C, C'.

Preferably, said traffic sensor 1 – 1'' in each traffic lane LA1 – LA3, LA1' – LA3', LB1 – LB3 comprises an alpha sensor 1.1 – 1.1'' and a beta sensor 1.2 – 1.2''. The alpha sensor 1.1 – 1.1'' and the beta sensor 1.2 – 1.2'' are arranged at a first sensor distance d1 from each other. The first sensor distance d1 is known and typically exhibits values to 1 m. In each traffic lane LA1 – LA3, LA1' – LA3', LB1 – LB3, the alpha sensor 1.1 – 1.1'' is arranged in front of the beta sensor 1.2 – 1.2'' in the travel direction of the vehicles C, C'. The vehicles C, C' traveling in a traffic lane LA1 – LA3, LA1' – LA3', LB1 – LB3 first pass over the alpha sensor 1.1 – 1.1'' and then over the beta sensor 1.2 – 1.2''. The velocity V of each of the vehicles C, C' can be determined using the first sensor distance d1 and by measuring the time period t taken to pass over the alpha sensor 1.1 – 1.1'' and the beta sensor 1.2 – 1.2'' in a traffic lane LA1 – LA3, LA1' – LA3', LB1 – LB3.

In the first embodiment of device D according to FIGS. 1 and 2, the first traffic sensor 1 comprises a first alpha sensor 1.1 and a first beta sensor 1.2 in the first traffic lane LA1 of the first access road A1, and the second traffic sensor 1' comprises a second alpha sensor 1.1' and a second beta sensor 1.2' in the second traffic lane LA2' of the second access road A2.

In the second embodiment of the device D according to FIGS. 3 and 4, the first traffic sensor 1 in the boundary area of the second and third bridge sections B2, B3 comprises a first alpha sensor 1.1 and a first beta sensor 1.2 in the first traffic lane LB1, the second traffic sensor 1' comprises a second alpha sensor 1.1' and a second beta sensor 1.2' in the second traffic lane LB2, and the third traffic sensor 1'' comprises a third alpha sensor 1.1'' and a third beta sensor 1.2'' in the third traffic lane LB3.

Each of the plurality of traffic sensors 1 – 1'' is configured to generate load data LD1 – LD3 for the detected load. Preferably, Each of the plurality of traffic sensors 1 – 1'' is configured to generate the load data LD1 – LD3 with a time resolution of less than or equal to 10 msec, preferably less than or equal to 1 msec, preferably less than or equal to 1 µsec. In the first embodiment of the device D according to FIGS. 1 and 2, the first traffic sensor 1 is configured to generate first load data LD1 and the second traffic sensor 1' is configured to generate second load data LD2. In the second embodiment of device D according to FIGS. 3 and 4, the first traffic sensor 1 is configured to generate first load data LD1, the second traffic sensor 1' is configured to generate second load data LD2, and the third traffic sensor 1'' is configured to generate third load data LD3. Preferably, said load data LD1 – LD3 are digital data.

While different sorts of traffic sensor 1 – 1'' can operate according to different sensor principles, preferably each of the plurality of traffic sensors 1 – 1'' is a WIM sensor 1 – 1''. Each WIM sensor 1 – 1'' desirably is configured with a cylindrical shape with a length of 1.0 m to 2.0 m and a diameter of 10 mm to 100 mm. Each WIM sensor 1 – 1'' desirably is inserted into a groove in the roadway LA, LA' of the access roads A1, A2 or the roadway LB of the bridge B, which groove is designed to be large enough so that the WIM sensor 1 – 1'' that is inserted into the groove does not protrude from the groove above the surface of the roadway LA, LA' of the access roads A1, A2 or the roadway LB of the bridge B. The groove and the WIM sensor 1 – 1'' inserted into the groove are filled with a casting compound flush with the surface of the roadway LA, LA' of the access roads A1, A2 or the roadway LB of the bridge B. Vehicles C, C' thus travel over the WIM sensor 1 – 1'' installed in the roadway LA, LA’ of the access roads A1, A2 or the roadway LB of bridge B.

Preferably, each of the plurality of WIM sensors 1 – 1'' is installed at an angle other than zero with respect to the travel direction of vehicles C, C' in the roadway LA, LA' of the access roads A1, A2 or the roadway LB of the bridge B, so that vehicles C, C' travel over the WIM sensor 1 – 1'' with all axles and all wheels.

Preferably, each of the plurality of WIM sensors 1 – 1'' includes a plurality of measuring elements along its length, which detect the load of each of the vehicles C, C' with a spatial resolution of a few centimeters at an angle other than zero relative to the travel direction. Due to this spatial resolution, the load data LD1 – LD3 contain at least one of the following traffic information: a load of a single wheel of a vehicle C, C', a position of each wheel of a vehicle C, C' in at least one traffic lane LA1 – LA3, LA1' – LA3', LB1 – LB3, a load of an axle of a vehicle C, C', a load of a vehicle C, C', a length of a vehicle C, C'. In particular, each of the plurality of WIM sensors 1 – 1'' is configured to detect whether a vehicle C, C' is traveling with its wheels in exactly one traffic lane LA1 – LA3, LA1' – LA3', LB1 – LB3, or whether a vehicle C, C' is traveling with its wheels in more than one traffic lane LA1 – LA3, LA1' – LA3', LB1 – LB3, for example when overtaking another vehicle C, C’ and changing traffic lanes LA1 – LA3, LA1' – LA3', LB1 – LB3.

Preferably, each of the plurality of WIM sensors 1 – 1'' is a piezoelectric WIM sensor 1 – 1''. Each of the plurality of piezoelectric WIM sensors 1 – 1'' includes piezoelectric material. The load of the vehicles C, C' acts as a gravitational force on the piezoelectric material and generates electrical charges. The number of electrical charges is proportional to the size of the load of the vehicles C, C'. Each of the plurality of piezoelectric WIM Sensors 1 – 1'' includes a charge amplifier and an analog-to-digital transducer. The charge amplifier is configured to amplify the number of charges into an analog electrical voltage, and the analog-to-digital transducer is configured to transduce the electrical voltage into digital load data LD1 – LD3.

The piezoelectric WIM sensors 1 – 1'' desirably are configured to detect the load of vehicles C, C' with a detection accuracy of less than or equal to 10.0%, preferably less than or equal to 5.0%, preferably less than or equal to 2.5%. In order to achieve this accuracy, the influence of disturbing forces must be kept as low as possible when detecting the load of vehicles C, C'. Such disturbing forces occur during the movement of said vehicles C, C'. The disturbing forces are also referred to as rolling forces and propagate as vibrations in the travel direction and against the travel direction in the underground U, U' of the access roads A1, A2 and in the structure T of the bridge B. These disturbing forces interfere with the measurement of the load of vehicles C and C' and thus distort the measurement of the load of vehicles C and C'.

In order to minimize such disturbing forces, in the first embodiment of the bridge B as a suspension bridge according to FIGS. 1 and 2, said piezoelectric WIM sensor 1 – 1'' is installed in the roadway LA, LA’ above the underground U, U' of the access roads A1, A2. This is because the structure T with tensioned steel cables and steel girders of the suspension bridge is designed to oscillate. Compared to this oscillating structure T, the underground U, U' of the access roads A1, A2 dampens the disturbing forces by at least one order of magnitude more strongly. This comparatively stronger damping of the disturbing forces in the underground U, U' of the access roads A1, A2 minimizes the influence of the disturbing forces on the detection of the load of the vehicles C, C'.

This is different in the second embodiment of bridge B as a prestressed concrete bridge according to FIGS. 3 and 4. The structure T of the prestressed concrete bridge is designed to be oscillating in the region of the prestressed concrete slabs outside the concrete girders and solid in the region of the concrete girders. The solid region of the structure T dampens the disturbing forces by at least one order of magnitude more strongly than the oscillating area. This comparatively stronger damping of the disturbing forces above the concrete girders of the structure T minimizes the influence of said disturbing forces on the detection of the load of the vehicles C, C'. Each of the plurality of piezoelectric WIM sensors 1 – 1'' is therefore installed in the roadway LB that is located above the concrete girders of structure T.

### THE STRUCTURE SENSOR 2 – 2'''

The device D includes at least one structure sensor 2 – 2''', and desirably a plurality of structure sensors 2 – 2’’’. Each structure sensor 2 – 2''' is configured to perform the function of detecting a structural response of the bridge B.

Preferably, each structure sensor 2 – 2''' is installed in the structure T of the bridge B. In both embodiments of the device D according to FIGS. 1-4, each structure sensor 2 – 2''' includes a first structure sensor 2, which is installed in the first bridge section B1, a second structure sensor 2', which is installed in the second bridge section B2, a third structure sensor 2'', which is installed in the third bridge section B3, and a fourth structure sensor 2''', which is installed in the fourth bridge section B4. Of course, the person skilled in the art can implement the invention with a number of structure sensors other than four.

The structural response of bridge B includes at least one of the following physical quantities: vibration, strain, displacement, or change in inclination. Accordingly, each of the structure sensors 2 – 2''' is at least one of the following types of sensors: an acceleration sensor for detecting a vibration, a strain sensor for detecting a strain, a displacement sensor for detecting a displacement, or an inclination sensor for detecting a change in inclination. Each of the different types of structure sensors 2 – 2''' can be configured to operate according to different sensor principles. The structure sensors 2 – 2''' can be miniaturized and manufactured as micro electro mechanical systems (MEMS).

Each of the plurality of structure sensors 2 – 2''' is configured to generate structural data SD1 – SD4 for the detected structural response. Preferably, each of the structure sensors 2 – 2''' is configured to generate the structural data SD1 – SD4 with a time resolution of less than or equal to 10 msec, preferably less than or equal to 1 msec, preferably less than or equal to 1 µsec. In the embodiment of device D according to FIG. 1, the structural data SD1 – SD4 includes first structural data SD1, which are generated by the first structure sensor 2 in the first bridge section B1, second structural data SD2, which are generated by the second structure sensor 2' in the second bridge section B2, third structural data SD3, which are generated by the third structure sensor 2'' in the third bridge section B3, and fourth structural data SD4, which are generated by the fourth structure sensor 2''' in the fourth bridge section B4. Preferably, the structural data SD1 – SD4 are digital data.

Preferably, the structure sensor 2 – 2''' is an acceleration sensor 2 – 2''' such as a capacitive acceleration sensor 2 – 2''', a piezoelectric acceleration sensor 2 – 2''', a piezoresistive acceleration sensor 2 – 2''', an optical acceleration sensor 2 – 2''', and so on. The acceleration sensor 2 – 2''' includes a housing via which it is attached to the structure T of the bridge B. A seismic mass is arranged in the housing. When the bridge B accelerates, the seismic mass changes its position relative to the housing due to its inertia and exerts a force proportional to its acceleration, which force generates a measurement signal. The acceleration sensor 2 – 2''' also desirably includes an analog-to-digital transducer, which transduces the measurement signal into digital structural data SD1 – SD4.

Preferably, the structure sensor 2 – 2''' is a strain sensor 2 – 2''' such as a strain gauge (SG) 2 – 2''', a piezoresistive sensor 2 – 2''', a piezoelectric sensor 2 – 2''', an optical sensor 2 – 2''', and so on. This type of strain sensor 2 – 2''' includes a housing via which it is attached to the structure T of the bridge B. Contact surfaces are arranged in the housing. Strain on the bridge B leads to a change in the distance between the contact surfaces. The change in distance generates a measurement signal. This type of strain sensor 2 – 2''' desirably includes an analog-to-digital transducer which transduces the measurement signal into digital structural data SD1 – SD4.

Preferably, the structure sensor 2 – 2''' is a displacement sensor 2 – 2''' such as a potentiometer sensor 2 – 2''', an inductive displacement sensor 2 – 2''', and so on. The displacement sensor 2 – 2''' includes a housing via which it is attached to the structure T of the bridge B. Reference points are arranged in the housing. A displacement of the bridge B between the reference points generates a measurement signal. The displacement sensor 2 – 2''' also desirably includes an analog-to-digital transducer, which transduces the measurement signal into digital structural data SD1 – SD4.

Preferably, the structure sensor 2 – 2''' is an inclination sensor 2 – 2''' such as a capacitive inclination sensor 2 – 2''. The inclination sensor 2 – 2''' includes a housing via which it is attached to the structure T of the bridge B. A capacitance is arranged in the housing. A change in the inclination of the bridge B generates a change in capacitance as a measurement signal. The inclination sensor 2 – 2''' desirably includes an analog-to-digital transducer, which transduces the measurement signal into digital structural data SD1 – SD4.

Each respective structure sensor 2 – 2''' is arranged at a known sensor distance d2 – d2''' from each respective traffic sensor 1 – 1''.

In the first embodiments of device D according to FIGS. 1 and 2, said structure sensor 2 – 2''' is arranged at a second sensor distance d2 – d2''' from the first traffic sensor 1 and at a third sensor distance d3 – d3''' from the second traffic sensor 1'. The first structure sensor 2 is arranged at a first second sensor distance d2 from the first traffic sensor 1 and at a first third sensor distance d3 from the second traffic sensor 1'. The second structure sensor 2' is arranged at a second second sensor distance d2' from the first traffic sensor 1 and at a second third sensor distance d3' from the second traffic sensor 1'. The third structure sensor 2'' is arranged at a third second sensor distance d2'' from the first traffic sensor 1 and at a third third sensor distance d3'' from the second traffic sensor 1'. And the fourth structure sensor 2''' is arranged at a fourth second sensor distance d2''' from the first traffic sensor 1 and at a fourth third sensor distance d3''' from the second traffic sensor 1'.

In the second embodiments of device D according to FIGS. 3 and 4, said structure sensor 2 – 2''' is arranged at a second sensor distance d2 – d2''' from the traffic sensors 1 – 1''. The first structure sensor 2 is arranged at a first second sensor distance d2 from the traffic sensors 1 – 1''. The second structure sensor 2' is arranged at a second second sensor distance d2' from the traffic sensors 1 – 1''. The third structure sensor 2'' is arranged at a third second sensor distance d2'' from the traffic sensors 1 – 1''. And the fourth structure sensor 2''' is arranged at a fourth second sensor distance d2''' from the traffic sensors 1 – 1''.

### THE ADDITIONAL TRAFFIC SENSOR 3 – 3''''

Device D may include at least one additional traffic sensor 3 – 3''''. The additional traffic sensor 3 – 3'''' is optional and is configured to perform the function of detecting at least one additional piece of traffic information relating to vehicles C, C' traveling over bridge B. In the context of the invention, "optional" means that the additional traffic sensor 3 – 3'''' does not necessarily have to be present in device D.

The additional traffic sensor 3 – 3'''' can be located on the access roads A1, A2, or on bridge B.

In the first embodiment of device D according to FIGS. 1 and 2, the additional traffic sensor 3 – 3'''' includes a first additional traffic sensor 3, which is arranged on the first access road A1, and a second additional traffic sensor 3', which is arranged on the second access road A2.

In the second embodiment of device D according to FIGS. 3 and 4, the additional traffic sensor 3 – 3'''' includes a first additional traffic sensor 3, which is arranged on the first bridge section B1, a second additional traffic sensor 3', which is arranged on the second bridge section B2, a third additional traffic sensor 3'' which is arranged on the boundary area of the second and third bridge sections B2, B3 at the traffic sensors 1 – 1'', a fourth additional traffic sensor 3''', which is arranged on the third bridge section B3, and a fifth additional traffic sensor 3'''' which is arranged on the fourth bridge section B4.

The additional traffic sensor 3 – 3'''' can operate according to any of a different number of sensor principles. Preferably, the additional traffic sensor 3 – 3'''' is at least one of the following sensors: an induction loop for detecting the presence of one of the vehicles C, C' as traffic information, an image sensor such as a camera, a video camera, and so on for detecting at least one of the following traffic information: an image of one of the vehicles C, C', a license plate of one of the vehicles C, C', a traffic lane LA1 – LA3, LA1' – LA3', LB1 – LB3 of one of the vehicles C, C', or a velocity sensor such as a radar device, a lidar device, and so on for detecting a velocity V of one of the vehicles C, C' as traffic information.

In the first embodiment of device D according to FIGS. 1 and 2, the additional traffic sensors 3, 3' are velocity sensors which generate additional traffic data TD1, TD2 for a detected velocity V of one of the vehicles C, C'. Thus, the velocity sensors can detect the velocity V of a vehicle C, C' that is traveling over the bridge B. The velocity sensors can thus also detect a change in the velocity V of a vehicle C, C' when traveling over the bridge B.

In the second embodiment of device D according to FIGS. 3 and 4, the additional traffic sensors 3 – 3'''' are image sensors, which generate additional traffic data TD1 – TD5 for a detected velocity V of one of the vehicles C, C'. The image sensors can thus detect a vehicle C, C' traveling over the bridge B in each bridge section B1 – B4. Thus, the image sensors can also detect the bridge section B1 – B4 in which a vehicle C, C' changes traffic lanes LB1 – LB3 when traveling over the bridge B.

Preferably, the additional traffic sensor 3 – 3'''' is configured to generate the additional traffic data TD1 – TD5 with a time resolution of less than or equal to 10 msec, preferably less than or equal to 1 msec, preferably less than or equal to 1 µsec. The first additional traffic sensor 3 generates first additional traffic data TD1. The second additional traffic sensor 3' generates second additional traffic data TD2. The third additional traffic sensor 3'' generates third additional traffic data TD3. The fourth additional traffic sensor 3''' generates fourth additional traffic data TD4. And the fifth additional traffic sensor 3'''' generates fifth additional traffic data TD5. Preferably, the additional traffic data TD1 – TD5 are digital data.

### THE ADDITIONAL STRUCTURE SENSOR 4, 4'

Said device D may include at least one additional structure sensor 4, 4'. The additional structure sensor 4, 4' is optional and is configured to perform the function of detecting at least one additional piece of information relating to the structure T of the bridge B. In the context of the invention, "optional" means that the additional structure sensor 4, 4' does not necessarily have to be present in the device D.

The additional structure sensor 4, 4' is arranged on the structure T of the bridge B. In the two embodiments of the device D according to FIGS. 1-4, the additional structure sensor 4, 4' includes a first additional structure sensor 4, which is arranged on the boundary area of the first and second bridge sections B1, B2, and a second structure sensor 4', which is arranged on the boundary area of the third and fourth bridge sections B3, B4.

The additional structure sensor 4, 4' can operate according to any of a number of different sensor principles. Preferably, the additional structure sensor 4, 4' is at least one of the following sensors: a temperature sensor for detecting the temperature on the bridge B, or a humidity sensor for detecting the humidity on the bridge B, or a wind sensor for detecting the wind speed on the bridge B.

In the two embodiments of the device D according to FIGS. 1-4, the first additional structure sensor 4 is a humidity sensor which generates first additional structural data AD1 for the detected humidity on the bridge B. And the second additional structure sensor 4' is a wind sensor which generates second additional structural data AD2 for the detected wind speed on the bridge B. Preferably, the additional structure sensor 4, 4' is configured to generate the additional structural data AD1, AD2, respectively, with a time resolution of less than or equal to 10 msec, preferably less than or equal to 1 msec, preferably less than or equal to 1 µsec. The additional structural data AD1, AD2, respectively, are preferably digital data.

### THE DETECTION UNIT 8

The device D includes at least one detection unit 8. The detection unit 8 is configured to perform the function of detecting the load data LD1 – LD3 and the structural data SD1 – SD4. If additional traffic data TD1 – TD5 or additional structural data AD1, AD2, respectively, are generated, then the detection unit 8 is configured to perform the additional function of detecting the additional traffic data AD1 – AD5 or additional structural data AD1, AD2, respectively.

The detection unit 8 is arranged spatially close to the bridge B. For the purposes of the invention, "spatially close" means a shortest distance of less than or equal to 1 km.

The detection unit 8 includes a computing unit and a data storage device. The computing unit may be a central processing unit (CPU), and so on. The data storage device may be a hard disk (HD), a solid-state disk (SSD), and so on.

### THE TRANSMISSION UNIT 5, 5', 6, 6', 7, 7', 9

The device D includes at least one transmission unit 5, 5', 6, 6', 7, 7', 9, and desirably includes a plurality of transmission units. Each transmission unit 5, 5', 6, 6', 7, 7', 9 is configured to perform the primary function of transmitting the load data LD1 – LD3 from the traffic sensor 1 – 1'' and the structural data SD1 – SD4 from the structure sensor 2 – 2''' to the detection unit 8. If additional traffic data TD1 – TD5 or additional structural data AD1, AD2, respectively, are available, then the transmission unit 5, 5', 6, 6', 7, 7', 9 is configured to perform the additional function of transmitting the additional traffic data TD1 – TD5 from the additional traffic sensor 3 – 3'''' or the additional structural data AD1, AD2, respectively, from the additional structure sensor 4, 4' to the recording unit 8.

The transmission unit 5, 5', 6, 6', 7, 7', 9 includes at least one field bus 5, 5' and at least one processing unit 6, 6'. The field bus 5, 5' includes an electrical conductor. The processing unit 6, 6' includes a computing unit and a data storage device. The computing unit can be a central processing unit (CPU), and so on. The data storage device can be a hard disk (HD), a solid-state disk (SSD), and so on.

The field bus 5, 5' electrically connects the structure sensor 2 – 2''' to the processing unit 6, 6'. If an additional structure sensor 4, 4' is present, then the field bus 5, 5' electrically connects the additional structure sensor 4, 4' to the processing unit 6, 6'.

In the embodiment of device D according to FIG. 1, the field bus 5, 5' includes a first field bus 5 and a second field bus 5', and the processing unit 6, 6' includes a first processing unit 6 and a second processing unit 6'.

Preferably, the field bus 5, 5' is a serial connection of up to twenty structure sensors 2 – 2''' and additional structure sensors 4, 4' with the processing unit 6, 6'. In the embodiment of device D according to FIG. 1, the first field bus 5 electrically connects the first and second structure sensors 2, 2' and the first additional structure sensor 4 in series with the first processing unit 6. The second field bus 5' electrically connects the third and fourth structure sensors 2'', 2''' and the second additional structure sensor 4' in series with the second processing unit 6'. Preferably, the field bus 5, 5' has a length of less than or equal to 100 m.

Preferably, the field bus 5, 5' is configured to wirelessly transmit digital data. For this purpose, the field bus 5, 5' is configured and disposed to transmit the structural data SD1 – SD4 and, if available, the additional structural data AD1, AD2 in accordance with a protocol in data packets from the structure sensor 2 – 2''' to the processing unit 6, 6'. The protocol can be Ethernet, EtherCAT (Ethernet for Control Automation Technology), Ethernet Powerlink, Single Pair Ethernet (SPE), Sercos III, and so on.

Preferably, the field bus 5, 5' is configured to synchronize the structure sensor 2 – 2''', and, if available, the additional structure sensor 4, 4' and the processing unit 6, 6' with a system time. For this purpose, the field bus 5, 5' desirably is configured to use Network Time Protocol (NTP), Precision Time Protocol (PTP), EtherCAT Sync Manager, EtherCat Distributed Clock, and so on. For the purposes of the invention, "synchronization" refers to a system time with a system accuracy of less than or equal to 10 msec, preferably less than or equal to 1 msec, preferably less than or equal to 1 µsec. Especially when the structure sensors 2 – 2''', and, if available, the additional structure sensors 4, 4' are arranged close to each other, very accurate synchronization using PTP or EtherCAT Distributed Clock of less than or equal to 1 µsec is required, as time deviations then exert a strong influence on the accuracy of the data evaluation.

Preferably, the field bus 5, 5' is configured and disposed to supply the structure sensor 2 – 2''', and, if present, the additional structure sensor 4, 4' with electrical energy. The supply of electrical energy can then be provided in accordance with EtherCAT-P with an electrical power of 24 V/3 A.

The processing unit 6, 6' is configured to store the structural data SD1 – SD4 that has been transmitted by the field bus 5, 5' and, if available, the additional structural data AD1, AD2 that has been transmitted by the field bus 5, 5' in the data memory. Preferably, up to eight field buses 5, 5' are electrically connected in parallel to a processing unit 6, 6'.

The transmission unit 5, 5', 6, 6', 7, 7', 9 includes at least one local network 7, 7'. The local network 7, 7' includes an electrical conductor or an optical waveguide. Preferably, the local network 7, 7' has a length of less than or equal to 1 km.

The local network 7, 7' is configured to connect the traffic sensor 1, 1' and the processing unit 6, 6' to the detection unit 8. If there is an additional traffic sensor 3 – 3''', then the local network 7, 7' also is configured to electrically connect the additional traffic sensor 3 – 3''' to the processing unit 6, 6'.

The local network 7, 7' includes a first local network 7 and a second local network 7'. Each of the first local network 7 and the second local network 7' may include a plurality of subnetworks, which are configured to transmit data via different protocols such as Ethernet, EtherCAT, Ethernet Powerlink, Single Pair Ethernet, Sercos III, and so on.

In the first embodiment of device D according to FIGS. 1 and 2, the first local network 7 is configured to connect the first traffic sensor 1, the first additional traffic sensor 3, and the first processing unit 6 to the detection unit 8. The second local network 7' is configured to connect the second traffic sensor 1', the second additional traffic sensor 3' and the second processing unit 6' to the detection unit 8.

In the second embodiment of device D according to FIGS. 3 and 4, the first local network 7 is configured to connect the traffic sensors 1 – 1'', the additional traffic sensors 3 – 3'''' and the first processing unit 6 to the detection unit 8. The second local network 7' is configured to connect the second processing unit 6' to the detection unit 8.

The local network 7, 7' is configured to connect the traffic sensor 1 – 1'' with the additional traffic sensor 3 – 3''''. Preferably, said traffic sensor 1 – 1'' is configured to generate at least one control signal SS – SS'' for the detected load of one of the vehicles C, C' in addition to the load data LD1 – LD3. The control signal SS – SS'' includes a first control signal SS from the first traffic sensor 1, a second control signal SS' from the second traffic sensor 1', and a third control signal SS'' from the third traffic sensor 1''. Preferably, the traffic sensor 1 – 1'' and the additional traffic sensor 3 – 3'''' are arranged in very close spatial proximity to each other. For the purposes of the invention, "in very close spatial proximity" means a shortest distance of less than or equal to 100 m. Preferably, the local network 7, 7' is configured to transmit the control signal SS – SS'' in real time from the traffic sensor 1 – 1'' to the additional traffic sensor 3 – 3''''.

In the first embodiment of device D according to FIGS. 1 and 2, the first local network 7 is configured to transmit the first control signal SS from the first traffic sensor 1 to the first additional traffic sensor 3, and the second local network 7' is configured to transmit the second control signal SS' from the second traffic sensor 1' to the second additional traffic sensor 3'. For the first control signal SS, the first additional traffic sensor 3 is configured to detect the velocity V of the first vehicle C, the load of which has been detected as first load data LD1, and to generate first additional traffic data TD1 for the detected velocity V. For the second control signal SS', the second additional traffic sensor 3' is configured to detect the velocity V of the second vehicle C', the load of which has been detected as second load data LD2, and to generate second additional traffic data TD2 for the detected velocity V.

In the second embodiment of device D according to FIGS. 3 and 4, the first local network 7 is configured to transmit the first control signal SS from the first traffic sensor 1 to the third additional traffic sensor 3'', the first local network 7 is configured to transmit the second control signal SS' from the second traffic sensor 1' to the third additional traffic sensor 3'', and the first local network 7 is configured to transmit the third control signal SS'' from the third traffic sensor 1'' to the third additional traffic sensor 3''. For the control signal SS – SS'', the third additional traffic sensor 3’' is configured to detect the license plate of the vehicle C, C', the load of which has been detected as load data LD1 – LD3, and to generate third additional traffic data TD3 for the detected velocity V.

Preferably, the local network 7, 7' is configured to transmit digital data. The nearby network 7, 7' is configured to transmit the load data LD1 – LD3 in accordance with a protocol in data packets from the traffic sensor 1 – 1'' to the detection unit 8. If available, the local network 7, 7' is configured to transmit the additional traffic data TD1 – TD5 in accordance with a protocol from the additional traffic sensor 3 – 3'''' to the detection unit 8. The local network 7, 7' is configured to transmit the structural data SD1 – SD4 in accordance with a protocol in data packets from the processing unit 6, 6' to the detection unit 8. And if available, the local network 7, 7' is configured to transmit the additional structural data AD1, AD2 in accordance with a protocol from the additional structure sensor 4, 4' to the detection unit 8. The protocol can be Ethernet, and so on.

Preferably, said local network 7, 7' is configured to synchronize the processing unit 6, 6' and the detection unit 8 with a system time. For this purpose, the local network 7, 7' can use NTP, PTP, EtherCAT Sync Manager, EtherCat Distributed Clock, and so on. Especially when the traffic sensors 1 – 1'' and, if available, the additional traffic sensors 3 – 3'''' are located close to each other, very precise synchronization using PTP of less than or equal to 1 µsec is required, as time deviations then exert a strong influence on the accuracy of the data evaluation.

The detection unit 8 is configured to record the load data LD1 – LD3 and structural data SD1 – SD4 that have been transmitted by the local network 7, 7', as well as, if available, any additional traffic data TD1 – TD5 or additional structural data AD1, AD2, respectively, and to store these data in the data memory.

The load data LD1 – LD3 and the structural data SD1 – SD4 and, if available, the additional traffic data TD1 – TD5 or the additional structural data AD1, AD2, respectively, are preferably digital data. However, based on the knowledge of the present invention, this data may also be analog signals. The transmission unit is then arranged to transmit analog signals to the detection unit. The detection unit then includes at least one analog-to-digital transducer, which is configured to transduce the analog signals into digital data.

### THE EVALUATION UNIT 10

The device D includes at least one evaluation unit 10, which is schematically shown in FIGS. 1 and 3. The evaluation unit 10 is configured to perform the function of evaluating the load data LD1 – LD3 and the structural data SD1 – SD4. If additional traffic data TD1 – TD5 or additional structural data AD1, AD2, respectively, are available, then the evaluation unit 10 is configured to perform the function of evaluating the additional traffic data TD1 – TD5 or the additional structural data AD1, AD2, respectively.

Preferably, the evaluation unit 10 is located at a remote distance from the bridge B. In the context of the invention, "at a remote distance" refers to a minimum distance of greater than or equal to 10 km.

The evaluation unit 10 includes a computing unit and a data storage device. The computing unit can be a central processing unit (CPU), and so on. The data storage device can be a hard disk (HD), a solid-state disk (SSD), and so on.

The transmission unit 5, 5', 6, 6', 7, 7', 9 is configured to perform the additional function of transmitting the load data LD1 – LD3, the structural data SD1 – SD4 and, if available, the additional traffic data TD1 – TD5 or the additional structural data AD1, AD2, respectively, from the detection unit 8 to the evaluation unit 10.

The transmission unit 5, 5', 6, 6', 7, 7', 9 includes at least one remote network 9¸ which can be wired or wireless.

The remote network 9 is configured to transmit the load data LD1 – LD3, the structural data SD1 – SD4 and, if available, the additional traffic data TD1 – TD5 or the additional structural data AD1, AD2, respectively, in accordance with a protocol in data packets from the recording unit 8 to the evaluation unit 10. The protocol can be Ethernet, and so on.

The load data LD1 – LD3 and the structural data SD1 – SD4 exhibit relative values XS, S, L, XL. For illustrative purposes, these relative values are simplified as XS (extra small), S (small), L (large), and XL (extra large), where XS denotes a very small value, S a small value, L a large value, and XL a very large value.

The remote network 9 is configured to transmit the load data LD1 – LD3, the structural data SD1 – SD4 and, if available, the additional traffic data TD1 – TD5 or the additional structural data AD1, AD2, respectively, with a bandwidth BW from the recording unit 8 to the evaluation unit 10. The bandwidth BW specifies the information content with which the load data LD1 – LD3, the structural data SD1 – SD4 and, if available, the additional traffic data TD1 – TD5 or the additional structural data AD1, AD2, respectively, are transmitted. The evaluation unit 10 is configured to adjust the bandwidth BW of the additional network 9. The bandwidth BW includes at least one of the following operating modes: normal or high. In the normal operating mode of the bandwidth BW, the information content of the transmitted load data LD1 – LD3 and structural data SD1 – SD4 and, if available, the additional traffic data TD1 – TD5 or the additional structural data AD1, AD2, respectively, is at least ten times lower than in the high operating mode of the bandwidth BW. The evaluation unit 10 is configured to adjust the transmission of load data LD1 – LD3, structural data SD1 – SD4 and, if available, additional traffic data TD1 – TD5 or additional structural data AD1, AD2, respectively, specifically to your requirements by adjusting the bandwidth BW.

The evaluation unit 10 is configured to adjust the bandwidth BW of the remote network 9 via control commands. Preferably, the bandwidth BW is in normal operating mode for very small values XS or small values S of the load data LD1 – LD3 and the structural data SD1 – SD4. For small values XS, S, the evaluation unit 10 does not require a high information content. The evaluation unit 10 then adjusts the bandwidth BW to normal. This is due to the fact that during the occurrence of very small values XS or small values S, the evaluation unit 10 requires high availability of the remote network 9, which is ensured by the normal bandwidth BW. Only when large values L or very large values XL of load data LD1 – LD3 and structural data SD1 – SD4 occur, will the evaluation unit 10 be configured to adjust the bandwidth BW to a high operating mode. This is due to the fact that during the occurrence of large values L or very large values XL, the evaluation unit 10 needs to evaluate load data LD1 – LD3 and structural data SD1 – SD4 with a high information content.

The evaluation unit 10 is configured to link the load data LD1 – LD3 and the structural data SD1 – SD4 to form a condition profile P for the bridge B. The condition profile P desirably is a time-dependent function that represents the temporal development of the load of the vehicles C, C' and the structural response of the bridge B.

The evaluation unit 10 is configured to link the values XS, S, L, XL of the load data LD1 – LD3 at time points t1 – t4 of the generation of the load data LD1 – LD3 with the values XS, S, L, XL of the structural data SD1 – SD4 at the same respective time points t1 – t4 of the generation of the structural data SD1 – SD4.

The load data LD1 – LD3 are generated by the traffic sensor 1 – 1'' with a time resolution of less than or equal to 1 µsec, and the structural data SD1 – SD4 are also generated by the structure sensor 2 – 2''' with a time resolution of less than or equal to 1 µsec. The load data LD1 – LD3 and the structural data SD1 – SD4 are transmitted by the transmission unit 5, 5', 6, 6', 7, 7', 9 to the evaluation unit 10 in a synchronized manner with a system accuracy of less than or equal to 1 µsec. This system accuracy ensures that the link between the load data LD1 – LD3 and the structural data SD1 – SD4 to the state profile P is correspondingly accurate. Due to this low system resolution and high system accuracy, it is possible to establish a cause-and-effect relationship between the temporal development of the load of the vehicles C, C' on the bridge B and the structural response of the bridge B with a high degree of certainty.

The first sensor distance d1 between the alpha sensor 1.1 – 1.1'' and the beta sensor 1.1 – 1.2'' of a traffic lane LA1 – LA3, LA1' – LA3' is known. For alpha sensors 1.1 – 1.1'' and beta sensors 1.2 – 1.2'', which are piezoelectric WIM sensors 1 – 1'', the load of vehicles C, C' is detected with a detection accuracy of less than or equal to 10.0%, preferably less than or equal to 5.0%, preferably less than or equal to 2.5%. The evaluation unit 10 is configured to compare the values XS, S, L, XL of the load data LD1 – LD3 of the alpha sensor 1.1 – 1.1'' of a traffic lane LA1 – LA3, LA1' – LA3' with the values XS, S, L, XL of the load data LD1 – LD3 of the beta sensor 1.2 – 1.2'' of this traffic lane LA1 – LA3, LA1' – LA3'. The evaluation unit 10 is configured to compare for the values XS, S, L, XL of the load data LD1 – LD3 of the alpha sensor 1.1 – 1.1'' of a traffic lane LA1 – LA3, LA1' – LA3', which, within the scope of the detection accuracy, are equal in size to the values XS, S, L, XL of the load data LD1 – LD3 of the beta sensor 1.2 – 1.2'' of the traffic lane LA1 – LA3, LA1' – LA3', to determine a time period t between the time points t1 – t4 at which the load data LD1 – LD3 of the alpha sensor 1.1 – 1.1'' and the beta sensor 1.2 – 1.2'' are generated with values XS, S, L, XL that are equal within the scope of the detection accuracy. The evaluation unit 10 is configured to divide the first sensor distance d1 by the time period t and thus to determine a velocity V of the vehicle C, C' the load of which has been recorded as load data LD1 – LD3.

The sensor distance d2 – d2''', d3 – d3''' between the traffic sensor 1 – 1'' and the structure sensor 2 – 2''' is known. The evaluation unit 10 is configured to divide the sensor distance d2 – d2''', d3 – d3''' between the traffic sensor 1 – 1'' and the structure sensor 2 – 2''' by the velocity V of the vehicle C, C', the load of which has been recorded as load data LD1 – LD3, and thus to determine a travel time TT. The evaluation unit 10 is configured to add the time point t1 – t4 of the generation of said load data LD1 – LD3 to the travel time TT, and thus to determine the time point t1 – t4 at which this vehicle C, C', depending on whether said structure sensor 2 – 2''' relative to the traffic sensor 1 – 1'' in the travel direction is arranged after the traffic sensor 1 – 1'' or before the traffic sensor 1 – 1'', is or was located above the structure sensor 2 – 2'''.

The evaluation unit 10 is configured to determine a number of approaches X for the time points t1 – t4 at which load data LD1 – LD3 are generated by the traffic sensor 1 – 1''. And since the bridge B is defined by a known length d, the evaluation unit 10 is configured to divide the length d by the velocity V of the vehicle C, C', the load of which has been recorded as load data LD1 – LD3, and thus to determine a presence time PT of this vehicle C, C' on the bridge B. Furthermore, the evaluation unit 10 is configured to divide the number of approaches X by the presence time PT and thus to determine a number of vehicles N on the bridge B.

Thus, the evaluation unit 10 is configured to link the time point t1 –t4 at which the load data LD1 – LD3 are generated by the traffic sensor 1 – 1'' by determining the travel time TT of one of the vehicles C, C', the load of which is recorded as load data LD1 – LD3, with the time point t1 – t4 at which the structural data SD1 – SD4 are generated by the structure sensor 2 – 2'''.

The evaluation unit 10 is configured to display the additional traffic data TD1 – TD5 in the order of the time points t1 – t4 at which the additional traffic data TD1 – TD5 were generated. The evaluation unit 10 is configured to recognize at least one of the following traffic information in the traffic data TD1 – TD5: the presence of one of the vehicles C, C', the image of one of the vehicles C, C', the license plate of one of the vehicles C, C', the traffic lane LA1 – LA3, LA1' – LA3', LB1 – LB3 of one of the vehicles C, C', the velocity V of one of the vehicles C, C'. The evaluation unit 10 is configured to display the movement of the vehicle C, C' in the order of the time points t1 – t4 of the traffic information recognized in the traffic data TD1 – TD5. The evaluation unit 10 is configured to display a change of traffic lane LA1 – LA3, LA1' – LA3', LB1 – LB3 during the movement of one of the vehicles C, C' in the order of time points t1 – t4 of the traffic lane LA1 – LA3, LA1' – LA3', LB1 – LB3 of said vehicle C, C'. The evaluation unit 10 is configured to display a change in the velocity V of a vehicle C, C' during the movement of said vehicle C, C' in the order of time points t1 – t4 of the image of the vehicle C, C' recognized in the traffic data TD1 – TD5 or the license plate of the vehicle C, C' recognized in the traffic data TD1 – TD5.

### THE CONDITION PROFILE P

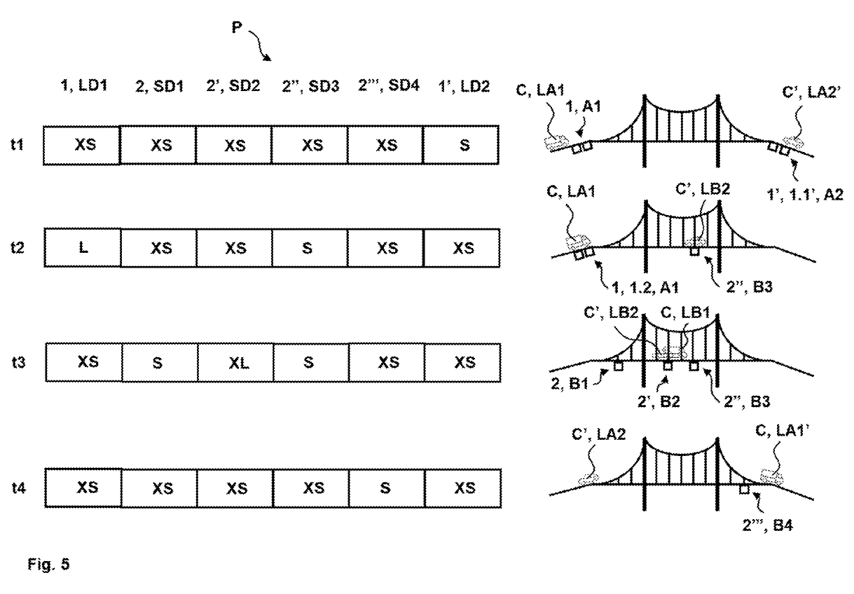

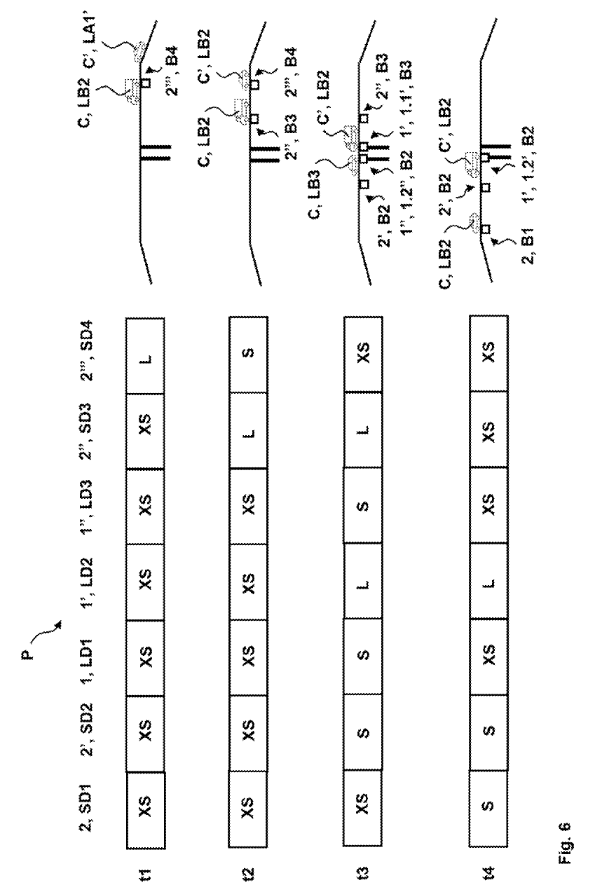

FIGS. 5 and 6 schematically show two examples of a condition profile P.

The example of the condition profile P according to FIG. 5 has been linked from the first embodiment of the device D according to FIGS. 1 and 2 to the embodiment of the bridge B and the access roads A1, A2 according to FIGS. 1 and 2.

Referring to FIG. 5, at the first time point t1, the first vehicle C is located in the first traffic lane LA1 of the first access road A1, spatially still in front of the first traffic sensor 1 of the first access road A1. Therefore, the first traffic sensor 1 does not detect any load and generates first load data LD1 with the value XS. The second vehicle C' is directly traveling in the second traffic lane LA2' of the second access road A2 over the second traffic sensor 1' of the second access road A2. The front axle of the second vehicle C' is located above the second A sensor 1.1' of the second traffic sensor 1'. The second traffic sensor 1' detects the load of the second vehicle C' of 2,000 kg and generates second load data LD2 with the value S for the detected load. The four structure sensors 2 – 2''' of the bridge B do not detect any structural response and therefore generate structural data SD1 – SD4 with the value XS.

At the second time point t2, the first vehicle C in the first lane LA1 of the first access road A1 is traveling straight over the first traffic sensor 1 of the first access road A1, while the second vehicle C' is in the second traffic lane LB2 in the third bridge section B3. The front axle of the first vehicle C is located above the first B sensor 1.2 of the first traffic sensor 1. The first traffic sensor 1 detects the load of the first vehicle C and generates first load data LD1 with the value L for the detected load of 10,000 kg. The second vehicle C' influences the structure T of the bridge B. The structural response of the bridge B is weak. For the affected structure T of bridge B, the third structure sensor 2'' of the third bridge section B3 generates third structural data SD3 with the value S. The second traffic sensor 1' does not detect any load and generates second load data LD2 with the value XS. Each of the first, second, and fourth structure sensors 2, 2', and 2''' also do not detect any structural response and therefore generate structural data SD1, SD2, and SD4 with the value XS.

At the third time point t3, the two vehicles C, C' are located on the second bridge section B2. The two vehicles C, C' cross each other in their traffic lanes LB1, LB2 and influence the structure T of the bridge B. The rear axles of the two vehicles C, C' are located above the second structure sensor 2' of the second bridge section B2. Due to the locally relatively large total load of 12,000 kg of the two vehicles C, C', the structural response of bridge B is very strong. For the affected structure T of bridge B, the second structure sensor 2' of the second bridge section B2 generates second structural data SD2 with the value XL. The first and third structure sensors 2, 2'' in the adjacent first and third bridge sections B1, B3 generate first and third structural data SD1, SD3 with the value S for the affected structure T of bridge B. The two traffic sensors 1, 1' do not detect any load and therefore generate load data LD1, LD2 with the value XS.

At the fourth time point t4, both vehicles C and C' have left the bridge B and are traveling on access roads A1 and A2. The first vehicle C is traveling in the first traffic lane LA1' of the second access road A2. Although the first vehicle C has left the bridge B, the first vehicle C still affects the structure T of bridge B due to its relatively large load of 10,000 kg. The structural response of bridge B is weak. For the affected structure T of bridge B, the fourth structure sensor 2''' of the fourth bridge section B4 generates fourth structural data SD4 with the value S. The second vehicle C' is directly driving in the second traffic lane LA2 of the first access road A1 over the first traffic sensor 1 of the first access road A1. The first, second, and third structure sensors 2 – 2'' of the bridge B do not detect any structural response and therefore generate first, second, and third structural data SD1 – SD3 with the value XS.

The example of the condition profile P according to FIG. 6 has been linked from the second embodiment of the device D according to FIGS. 3 and 4 for the embodiment of the bridge B and the access roads A1, A2 according to FIGS. 3 and 4.

At the first time point t1, the first vehicle C in the second traffic lane LB2 of bridge B is traveling directly over the fourth structure sensor S''' of the fourth bridge section B4. The first vehicle C influences the structure T of bridge B. The structural response of bridge B is strong. For the affected structure T of bridge B, the fourth structure sensor 2''' of the fourth bridge section B4 generates fourth structural data SD4 with the value L. The second vehicle C' is located in the first traffic lane LA1' of the second access road A2, still spatially in front of the bridge B. The traffic sensors 1 – 1'' do not detect any load and generate load data LD1 – LD3 with the value XS. The first, second, and third structure sensors 2 – 2'' of bridge B also do not detect any structural response and therefore generate structural data SD1 – SD3 with the value XS.

At the second time point t2, the first vehicle C continues to travel in the second lane LB2 of the bridge B, passing directly over the third structure sensor S'' of the third bridge section B3. The first vehicle C influences the structure T of the bridge B. The structural response of the bridge B is strong. For the affected structure T of the bridge B, the third structure sensor 2'' of the third bridge section B3 generates third structural data SD3 with the value L. The second vehicle C', which is traveling comparatively faster, starts to overtake the first vehicle C. Therefore, the second vehicle C' has changed traffic lane and is now in the second traffic lane LB2 of bridge B, directly above the fourth structure sensor S''' of the fourth bridge section B4. The second vehicle C' influences the structure T of bridge B. The structural response of bridge B is weak. For the affected structure T of bridge B, the fourth structure sensor 2''' of the fourth bridge section B4 generates fourth structural data SD4 with the value S. The traffic sensors 1 – 1'' do not detect any load and generate load data LD1 – LD3 with the value XS. The first and second structure sensors 2, 2' of the bridge B also do not detect any structural response and therefore generate structural data SD1, SD2 with the value XS.

At the third time point t3, the second vehicle C' in the third traffic lane LB3 of the bridge B has just overtaken the first vehicle C in the second traffic lane LB2 of the bridge B. The two vehicles C and C' are located at the boundary between the second and third bridge sections B2 and B3. The rear axle of the second vehicle C' is located directly above the third B sensor 1.2'' of the third traffic sensor 1'' of the second bridge section B2. The third traffic sensor 1'' detects the load of the second vehicle C' of 2,000 kg and generates third load data LD3 with the value S for the detected load. The front axle of the first vehicle C is directly above the second A sensor 1.1' of the second traffic sensor 1' of the third bridge section B3. The second traffic sensor 1' detects the load of the first vehicle C of 10,000 kg and generates second load data LD2 with the value L for the detected load. The two vehicles C, C' influence the structure T of the bridge B. Due to the locally relatively large total load of 12,000 kg of the two vehicles C, C', the structural response of the bridge B is strong. For the affected structure T of the bridge B, the second structure sensor 2' of the second bridge section B2 generates second structural data SD2 with the value S. The third structure sensor 2'' in the third bridge section B1, B3 generates third structural data SD3 with the value L for the affected structure T of the bridge B. The first and fourth structure sensors 2, 2''' of the bridge B do not detect any structural response and therefore generate structural data SD1, SD4 with the value XS.

At the fourth time point t4, the second vehicle C' has changed back into the second traffic lane LB2 of bridge B and is traveling straight over the first structure sensor S of the first bridge section B1, while the comparatively slower first vehicle C is still in the second traffic lane LB2 of the bridge B. The rear axle of the first vehicle C is traveling directly over the second B sensor 1.2' of the second traffic sensor 1' of the second bridge section B2. The second traffic sensor 1' detects the load of the first vehicle C of 10,000 kg and generates second load data LD2 with the value L for the detected load. The two vehicles C, C' influence the structure T of bridge B. The structural response of the bridge B is weak. For the affected structure T of the bridge B, the first structure sensor 2 generates first structural data SD1 with the value S, and the second structure sensor 2 also generates second structural data SD2 with the value S.

### LIST OF REFERENCE NUMERALS

1 – 1'' Traffic sensor
1.1 – 1.1' alpha sensor
1.2 – 1.2' beta sensor
2 – 2''' Structure sensor
3 – 3'''' Additional traffic sensor
4, 4' Additional structure sensor
5, 5' Field bus
6, 6' Processing unit
7, 7' Local network
8 Detection unit
9 Remote network
10 Evaluation unit
A1, A2 Access road
AD1, AD2 Additional structural data
B Bridge
B1 – B4 Bridge section BW Bandwidth
C, C' Vehicle
d Length of the bridge
d1 First sensor distance
d2 – d2''' Second sensor distance
d3 – d3''' Third sensor distance
D Device
L Roadway
LA1 – LA3 Traffic lane of the access road
LB1 – LB3 Traffic lane of the bridge
LD1 – LD3 Load data
N Number of vehicles
P Condition profile
PT Presence time
SD1 – SD4 Structural data
SS – SS'' Control signal
t Time period
t1 – t4 Time point
T Structure
TD1 – TD5 Additional traffic data
TT Travel time
U, U' Underground
V Velocity
X Number of approaches
XS, S, L, XL Relative Values

What is claimed is:

1. A method for determining the condition of a bridge spanning a length, the method comprising the following steps:
generating load data from each of a plurality of traffic sensors, which are configured and disposed for detecting the load of each of a plurality of vehicles traveling over the bridge;
providing the generated traffic sensor load data to an evaluation unit that is configured to evaluate the load data;
from at least one structure sensor that is configured and disposed to detect a structural response of the bridge, which structural response includes at least one of the following physical quantities: a vibration, a strain, a displacement, and a change in inclination, generating structural data for the detected structural response; and
using the evaluation unit to link the load data and the structural data to generate a condition profile of the bridge, which condition profile provides the detected structural response of the bridge at a given point in time relative to the evaluated load data of the plurality of vehicles at the given point in time.

2. The method according to claim 1, wherein load data is generated by a first one of the plurality of traffic sensors at a plurality of successive time points; wherein structural data is generated by the structure sensor at a plurality of successive time points; and wherein the evaluation unit links a respective one of the plurality of successive time points at which the load data is generated with a respective one of the plurality of successive time points at which the structure data is generated, in the condition profile.

3. The method according to claim 2, wherein the load data are generated by the traffic sensor with a time resolution of no more than 10 msec; wherein the structural data are generated by the structure sensor with a time resolution of no more than 10 msec; and using a transmission unit to transmit the load data of each of the plurality of traffic sensors and the structural data of each of the plurality of structure sensors to the evaluation unit synchronized with a system accuracy of no more than 10 msec.

4. The method according to claim 2, wherein the load data are generated by the traffic sensor with a time resolution of no more than 1 msec; wherein the structural data are generated by the structure sensor with a time resolution of no more than 1 msec; and using a transmission unit to transmit the load data of each of the plurality of traffic sensors and the structural data of each of the plurality of structure sensors to the evaluation unit synchronized with a system accuracy of no more than 1 msec

5. The method according to claim 2, wherein the evaluation unit links each specific value of the load data and each specific value of the structural data at a respective time point of the generation of the load data with each specific value of the structural data at the respective time point of the generation of the structural data.

6. The method according to claim 5, wherein a respective one of the plurality of vehicles travels in a respective one of a plurality of traffic lanes in one travel direction, from which each of the plurality of traffic sensors in each of the plurality of traffic lanes load data with a spatial resolution of a few centimeters at an angle other than zero relative to the travel direction are detected for the load of the plurality of vehicles, which load data contain at least one of the following traffic information: a load of a single wheel of a vehicle, a position of each wheel of a vehicle in at least one traffic lane, a load of an axle of a vehicle, a load of a vehicle, a length of a vehicle.

7. The method according to claim 5, the plurality of vehicles travels in a roadway that includes a plurality of traffic lanes in one travel direction, which one of a plurality of traffic sensors in each of the plurality of traffic lanes includes a first sensor and a second sensor, from which first sensor load data are generated for the load of the plurality of vehicles, and from which second sensor load data are generated for the load of the plurality of vehicles, which load data includes the specific values.

8. The method according to claim 7, wherein the first sensor and the second sensor are arranged at a first sensor distance from each other, wherein the evaluation unit compares the specific values of the load data of the first sensor with the specific values of the load data of the second sensor; wherein the evaluation unit determines for the specific values of the load data of the first sensor, which, within a detection accuracy are equal to the specific values of the load data of the second sensor, a time period between the time points of the generation of the load data of the first sensor and the second sensor with amounts which are within the detection accuracy; and wherein the evaluation unit divides the first sensor distance by the time period and thus to determine a velocity of the vehicle the load of which has been detected as load data.

9. The method according to claim 7, further comprising using a velocity sensor to detect the velocity of one of the plurality of vehicles; wherein at least one control signal for a detected load of one of the plurality of vehicles in addition to the load data is also generated by the traffic sensor; wherein the velocity of the one of the plurality of vehicles the load of which has been detected as load data is also detected by the velocity sensor for the control signal; and wherein additional data are generated by the velocity sensor for the detected velocity of the one of the plurality of vehicles.

10. The method according to claim 7, further comprising detecting a license plate of one of the plurality of vehicles; a control signal for a detected load of the one of the plurality of vehicles in addition to the load data is also generated by one of the plurality of traffic sensors; the license plate of the vehicle the load of which has been detected as load data is detected by an additional traffic sensor for the control signal; and wherein additional data are generated by the additional traffic sensor for the detected license plate of the vehicle.

11. The method according to claim 6, further comprising providing an additional traffic sensor configured for detecting at least one of the following traffic information: a presence of one of the vehicles, an image of one of the vehicles, a license plate of one of the vehicles, a traffic lane of one of the vehicles;generating additional traffic sensor data from the additional traffic sensor for the detected traffic information; the additional traffic data are generated by the additional traffic sensor at a plurality of time points; and wherein the evaluation unit displays the additional traffic data in the order of the plurality of time points at which the additional traffic data are generated.

12. The method according to claim 11, wherein the evaluation unit recognizes the traffic information in the traffic data; wherein the evaluation unit displays the movement of the vehicle in the order of the plurality of time points of the traffic information recognized in the traffic data; and wherein the evaluation unit displays a change of the traffic lane during the movement of one of the vehicles in the order of the plurality of time points of the traffic lane of the vehicle recognized in the traffic data.

13. The method according to claim 11, wherein the evaluation unit recognizes the traffic information in the traffic data; wherein the evaluation unit displays the movement of the vehicle in the order of the plurality of time points of the traffic information recognized in the traffic data; and wherein the evaluation unit displays a change in the velocity of a vehicle during the movement of the vehicle in the order of the plurality of time points of the image of the vehicle recognized in the traffic data or the license plate of the vehicle recognized in the traffic data.

14. The method according to claim 8, wherein each of the plurality of traffic sensors [RG1] and the structure sensor are arranged at a respective sensor distance relative to each other, wherein the evaluation unit divides the respective sensor distance by the velocity of the respective vehicle, the respective load of which has been detected as load data, and thus determines a travel time; and wherein the evaluation unit adds the time point at which the respective load data were generated to the travel time, thereby determining the time point at which the respective vehicle is located above the structure sensor. [RG1]

15. The method according to claim 8, wherein the evaluation unit determines a number of approaches for the plurality of time points of the generation of load data by the traffic sensor; wherein the evaluation unit divides the length of the bridge by the velocity of the vehicle the load of which has been detected as load data, and thus determines a presence time of this vehicle on the bridge; and wherein the evaluation unit divides the number of approaches by the presence time and thus determines a number of vehicles on the bridge.

16. The method according to claim 1, wherein a detection unit that is arranged spatially close to the bridge, detects the load data and the structural data; wherein the evaluation unit is arranged spatially remote from the bridge and at least one remote network transmits the load data and the structural data from the detection unit (8) to the evaluation unit; and wherein the evaluation unit adjusts a bandwidth of the remote network, which bandwidth includes at least one of the following operating modes: normal or high, and in the normal operating mode of the bandwidth, an information content of the transmitted load data and structural data transmitted is at least ten times lower than in the high operating mode of the bandwidth.

17. A device for determining the condition of a bridge over which a plurality of vehicles may travel on a roadway of the bridge, the device comprising:
a plurality of traffic sensors, each of the plurality of traffic sensors being configured and disposed for detecting a load of each vehicle of a plurality of vehicles traveling over the bridge, each of the plurality of traffic sensors being configured to generate load data for a detected load for each of the plurality of vehicles traveling over the bridge;
a structure sensor disposed for detecting a structural response of the bridge, which structural response includes at least one of the following physical quantities: a vibration, a strain, a displacement, and a change in inclination of the bridge, which structure sensor is configured to generate structural data for the detected structural response;
an evaluation unit for evaluating the load data for each of the plurality of vehicles, wherein the evaluation unit is operatively connected to the plurality of traffic sensors and to the structure sensor; and
wherein the evaluation unit is configured to link the evaluated load data and the structural data to form a condition profile of the bridge, which condition profile provides the detected structural response of the bridge at a given point in time relative to the evaluated load data of the plurality of vehicles at the given point in time.

18. The device according to claim 17, wherein the bridge includes a plurality of access roads arranged outside the bridge on an underground and including a roadway for the plurality of vehicles;
wherein the bridge includes a structure designed to oscillate in certain regions of the structure;
wherein during the movement of the plurality of vehicles rolling forces occur and propagate as vibrations in the travel direction and against the travel direction in the structure and in the underground and interfere with the detection of the load of the vehicles by the plurality of traffic sensors and distort the detection of the load of the plurality of vehicles by the plurality of traffic sensors;
wherein each of the plurality of traffic sensors is a WIM sensor;
wherein the underground is configured to dampen the rolling forces by at least one order of magnitude more strongly than the structure is configured to dampen the rolling forces; and
wherein each of the plurality of traffic sensors is installed in the roadway of the plurality of access roads.

19. The device according to claim 17, wherein the roadway of the bridge includes a structure having a solid region and an oscillating region spaced apart from the solid region;
wherein during the movement of the plurality of vehicles in a travel direction, rolling forces occur and propagate as vibrations in the travel direction and against the travel direction in the structure and in an underground, which rolling forces interfere with the detection of the load of the plurality of vehicles by the plurality of traffic sensors and distort the detection of the load of each of the plurality of vehicles by the plurality of traffic sensors;
wherein each of the plurality of traffic sensors is a WIM sensor;
wherein the solid region of the structure is configured to dampen the rolling forces by at least one order of magnitude more strongly than the oscillating of the structure is configured to dampen the rolling forces; and
wherein each of the plurality of traffic sensors is installed in the roadway in the solid region of the structure.

20. The device according to claim 17, further comprising a field bus and a processing unit electrically connected to the field bus, which electrically connects the structure sensor to the processing unit;
wherein the field bus is configured to transmit the structural data from the structure sensor to the processing unit in accordance with a protocol; and
wherein the field bus is configured to synchronize the structure sensor and the processing unit with a system time with a system accuracy of less than or equal to 10 msec.

21. The device according to claim 20, wherein the field bus is configured to supply electrical energy to the structure sensor.

22. The device according to claim 20, further comprising a local network and a detection unit;
wherein the detection unit is arranged spatially close to the bridge;
wherein the local network electrically connects each of the plurality of the traffic sensors and the processing unit to the detection unit;
wherein the local network is configured to transmit the load data from the plurality of traffic sensors to the detection unit;
wherein the local network is configured to transmit the structural data from the structure sensor to the detection unit in accordance with a protocol; and
wherein the local network is configured to synchronize each of the plurality of traffic sensors and the detection unit with a system time of less than or equal to 1 msec.
